(19) United States
(12) Patent Application Publication
(10) Pub. No.: US 2023/0415450 A1
(43) Pub. Date: Dec. 28, 2023

(54) LAMINATE, SHAPED ARTICLE, MOLDED ARTICLE, METHOD FOR MANUFACTURING LAMINATE, METHOD FOR MANUFACTURING SHAPED ARTICLE, AND METHOD FOR MANUFACTURING MOLDED ARTICLE

(71) Applicant: Panasonic Holdings Corporation, Osaka (JP)

(72) Inventors: Tomonori SUGIYAMA, Osaka (JP); Kazuhiko KANEUCHI, Osaka (JP); Takashi MORIMOTO, Osaka (JP); Hiroshi MORIOKA, Osaka (JP); Hideki CHIBA, Okayama (JP); Makoto UTSUMI, Hyogo (JP); Kazuya KUSU, Nara (JP)

(21) Appl. No.: 18/213,939

(22) Filed: Jun. 26, 2023

(30) Foreign Application Priority Data
Jun. 28, 2022 (JP) 2022-103925
May 26, 2023 (JP) 2023-086817

(51) Int. Cl. B32B 5/02; B32B 7/12; B32B 27/12; B32B 33/00; B32B 38/00

(52) U.S. Cl. CPC B32B 5/022; B32B 7/12; B32B 27/12; B32B 33/00; B32B 38/0004; B32B 2250/02; B32B 2255/10; B32B 2305/18; B32B 2451/00

(57) ABSTRACT

Provided is a laminate that can be pre-trimmed and can eliminate the need for a post-processing step. A laminate includes a decorative layer, an adhesive layer, and a support layer laminated in this order. The support layer includes two or more kinds of materials having different melting points including a material having a relatively low melting point and a material having a relatively high melting point.

### BACKGROUND

### 1. Technical Field

The present disclosure relates to a laminate, a shaped article, a molded article, a method for manufacturing a laminate, a method for manufacturing a shaped article, and a method for manufacturing a molded article.

### 2. Description of the Related Art

In recent years, in exterior parts of home appliances, in-vehicle interior parts, and the like, there is an increasing need for a decoration method having a wide range of design expression and high grade designability due to diversification of customer orientation. As one of the decoration methods, there is an insert molding method in which a decorative material is positioned and fixed in an injection molding mold and integrated with an injected resin. By using this insert molding method, for example, it is possible to obtain a molded article using a decorative material produced in sheets, such as a sliced veneer obtained by thinly slicing wood or a decorative film printed on a thick base material. On the other hand, when the decorative material produced in these sheets is insert-molded, a mechanism for fixing the decorative material to the injection molding mold is generally required, such as making a positioning hole in a margin of the outer periphery of the product on the decorative material side and providing a pin for setting the positioning hole on the injection molding mold side. It should be noted that the insert molding defined in the present disclosure refers to a method of forming the entire external appearance surface of a product with a decorative material, and includes a shape of involving the decorative material from the external appearance surface to the back side of the product depending on product specifications.

Japanese Patent No. 6288825 discloses a resin molded member using a composite sheet made of a resin film, a nonwoven fabric, or the like. This configuration is shown in FIGS. 13 and 14.

A composite sheet 200 in FIG. 13 includes a resin film 101, a fabric material 102, a resin film 103, and a nonwoven fabric 104. The resin film 101 is formed on one surface side of the fabric material 102 with interposition of a molten adhesive filling layer, and the resin film 103 and the nonwoven fabric 104 are sequentially formed on another surface side of the fabric material 102 with interposition of the same molten adhesive filling layer. In addition, as shown in FIG. 14, the resin molded member 202 is formed by integrating the surface on which the nonwoven fabric 104 is formed of the composite sheet 200 and the base material resin 201 by injection molding.

JP 2012-218432 A discloses a composite sheet in which a woven fabric and a plastic sheet are integrated. This configuration is shown in FIGS. 15 and 16. The composite sheet 400 is obtained by integrating the woven fabric 301 and the transparent hard acrylic resin sheet 303 with interposition of the adhesive 302. The woven fabric 301 is impregnated with a thermoplastic resin, and the composite sheet 400 is deformed into the three-dimensional molded product 304 and then molded and integrated with the base material resin, thereby forming the composite three-dimensional molded product 305.

In the conventional example of Japanese Patent No. 6288825, when the composite sheet 200 and the base material resin 201 are integrated by injection molding, the adhesive layer (with the base material resin 201) formed on the outer surface of the resin film 103 due to heat, pressure, or resin flow of the base material resin 201 is prevented from melting and flowing out. However, as described in Japanese Patent No. 6288825, it cannot be expected to increase the rigidity of the composite sheet 200 itself. That is, the rigidity of the composite sheet 200 is not sufficient, and the composite sheet 200 alone does not stand by itself. Therefore, it is difficult to position and fix the composite sheet 200 alone to a mold without providing a fixing mechanism to the mold. As a result, when the resin molded member 202 is obtained, the composite sheet 200 cut with a margin with respect to the size of the molded article is attached to the mold fixing side with a positioning pin, and then the composite sheet 200 and the base material resin 201 are integrated by injection molding. Therefore, post-processing processing of trimming a loose portion of the composite sheet 200 protruding to the outer periphery of the molded body is separately required.

In addition, in the conventional example of JP 2012-218432 A, the processing followability as the composite sheet 400 is improved by applying impregnation processing to the woven fabric 301, but it is necessary to trim, into a predetermined shape, an unnecessary portion of the three-dimensional molded product 304 after vacuum molding. Therefore, post-processing processing occurs in a series of processes for obtaining the composite three-dimensional molded product 305 by integrating with the base material resin.

As in these conventional examples, devices have been made to improve product shape followability at the time of processing, but there remains a problem in achieving eliminating post-processing processing during a series of molding processing processes.

### SUMMARY

The present invention was conceived in view of the situations, and it is therefore one non-limiting and exemplary embodiment provides a laminate that can be pre-trimmed and does not require a post-processing step.

A laminate according to the present disclosure includes a decorative layer, an adhesive layer, and a support layer laminated in this order. The support layer includes two or more kinds of materials having different melting points including a material having a relatively low melting point and a material having a relatively high melting point.

A shaped article according to the present disclosure includes a decorative layer, a first adhesive layer, and a support layer laminated in this order. The support layer includes two or more kinds of materials having different melting points including a material having a relatively low melting point and a material having a relatively high melting point. The material having a low melting point included in the support layer is fused between the materials having a high melting point included in the support layer to form a cross-linked structure, and a shape is retained.

A molded article according to the present disclosure includes: the shaped article; and an injection molding resin integrated with the shaped article.

A molded article according to the present disclosure includes: one member to be selected from a group of a resin member, a metal member, a glass member, a ceramic member, and a wooden member; and the shaped article bonded to a surface of the member.

A method for manufacturing a laminate according to the present disclosure includes the steps of: laminating a decorative layer, a first adhesive layer, and a support layer in this order; and thermocompression-bonding the decorative layer, the first adhesive layer, and the support layer which are laminated.

A method for manufacturing a shaped article according to the present disclosure includes the steps of: trimming the laminate according to any one of the first to fourth aspects into a predetermined shape; and aligning and fixing the trimmed laminate, and performing hot press working.

A method for manufacturing a molded article according to the present disclosure includes the steps of: aligning and fixing the shaped article according to the fifth aspect to an injection molding mold, and mold-clamping the injection molding mold; pouring a resin into a cavity between the injection molding molds in a state where the injection molding mold is mold-clamped; and after the resin is cured, mold-opening the injection molding mold to take out a molded article in which the shaped article and the cured resin are integrated.

A method for manufacturing a molded article according to the present disclosure includes obtaining a molded article obtained by bonding the shaped article according to the fifth aspect to a surface of one member to be selected from a group of a resin member, a metal member, a glass member, a ceramic member, and a wooden member.

According to the laminate of the present disclosure, by thermocompression bonding at the time of manufacturing the laminate, the low-melting-point material included in the support layer constituting the laminate is melted, and fused to the high-melting-point material included in the support layer to form a cross-linked structure between the high-melting-point materials. Therefore, the density of the support layer is improved, the hardness of the support layer itself is improved, and the laminate can stand on its own. Thus, since alignment can be performed even in the subsequent hot press working and manufacturing step of the molded article, pre-trimming can be performed, and the post-processing step does not need to be performed.

Additional benefits and advantages of the disclosed embodiments will be apparent from the specification and figures. The benefits and/or advantages may be individually provided by the various embodiments and features of the specification and drawings disclosure, and need not all be provided in order to obtain one or more of the same.

### BRIEF DESCRIPTION OF DRAWINGS

The present disclosure will become readily understood from the following description of non-limiting and exemplary embodiments thereof made with reference to the accompanying drawings, in which like parts are designated by like reference numeral and in which:

FIG. 1A is a schematic cross-sectional view showing a cross-sectional structure of a laminate according to a first embodiment;

FIG. 1B is a SEM photograph (500 times) showing a cross-linked structure of a support layer in the laminate in FIG. 1A;

FIG. 2 is a schematic cross-sectional view showing a cross-sectional structure of a decorative film used as the decorative layer used in the laminate according to the first embodiment;

FIG. 3 is a schematic cross-sectional view showing a cross-sectional structure of a laminate in which a protective layer is formed on a surface of the laminate according to the first embodiment;

FIG. 4 is a schematic cross-sectional view showing one step of the method for manufacturing the laminate according to the first embodiment;

FIG. 5A is a plan view showing a configuration in which the laminate according to the first embodiment is pre-trimmed to a predetermined shape, and FIG. 5B is a cross-sectional view of the laminate before trimming;

FIG. 6 is a schematic cross-sectional view showing a state before hot press working in the method for manufacturing a shaped article according to the first embodiment;

FIG. 7 is a schematic cross-sectional view showing a state at the time of hot press working in the method for manufacturing a shaped article according to the first embodiment;

FIG. 8 is a schematic cross-sectional view showing a state after hot press working in the method for manufacturing a shaped article according to the first embodiment;

FIG. 9 is a schematic cross-sectional view showing a molded article obtained by injection molding in the method for manufacturing a molded article according to the first embodiment;

FIG. 10 is a schematic cross-sectional view showing a cross-sectional structure of a laminate according to a second embodiment;

FIG. 11 is a schematic cross-sectional view showing a cross-sectional structure of a laminate of another example according to the second embodiment;

FIG. 12 is a schematic cross-sectional view showing a cross-sectional structure of a molded article according to a third embodiment;

FIG. 13 is a schematic cross-sectional view showing a cross-sectional structure of a composite sheet of Japanese Patent No. 6288825;

FIG. 14 is a schematic cross-sectional view showing a cross-sectional structure of a resin molded member obtained by injection-molding the composite sheet of Japanese Patent No. 6288825;

FIG. 15 is a schematic cross-sectional view showing a cross-sectional structure of a composite sheet of JP 2012-218432 A; and

FIG. 16 is a schematic cross-sectional view showing a cross-sectional structure of a composite three-dimensional molded product obtained by injection-molding the composite sheet of JP 2012-218432 A.

### DETAILED DESCRIPTION

The laminate according to a first aspect is a laminate including a decorative layer, a first adhesive layer, and a support layer laminated in this order. The support layer includes two or more kinds of materials having different melting points including a material having a relatively low melting point and a material having a relatively high melting point.

In the laminate according to a second aspect, in the first aspect, the low melting point material included in the support layer may be fused between the high melting point materials included in the support layer to form a cross-linked structure.

In the laminate according to a third aspect, in the first aspect, the first adhesive layer may penetrate into the support layer and may be bonded and integrated with the support layer, and the first adhesive layer may cover a front surface of the support layer.

In the laminate according to a fourth aspect, in the first aspect, a base material layer may be formed between the decorative layer and the first adhesive layer.

The shaped article according to a fifth aspect is a shaped article including a decorative layer, a first adhesive layer, and a support layer laminated in this order. The support layer includes two or more kinds of materials having different melting points including a material having a relatively low melting point and a material having a relatively high melting point. The material having a low melting point included in the support layer is fused between the materials having a high melting point included in the support layer to form a cross-linked structure, and a shape is retained.

The molded article according to a sixth aspect includes: the shaped article according to the fifth aspect; and an injection molding resin integrated with the shaped article.

The molded article according to a seventh aspect includes: one member to be selected from a group of a resin member, a metal member, a glass member, a ceramic member, and a wooden member; and the shaped article according to the fifth aspect bonded to a surface of the member.

The method for manufacturing a laminate according to an eighth aspect includes the steps of: laminating a decorative layer, a first adhesive layer, and a support layer in this order; and thermocompression-bonding the decorative layer, the first adhesive layer, and the support layer which are laminated.

The method for manufacturing a shaped article according to a ninth aspect includes the steps of: trimming the laminate according to any one of the first to fourth aspects into a predetermined shape; and aligning and fixing the trimmed laminate, and performing hot press working.

The method for manufacturing a molded article according to a tenth aspect includes the steps of: aligning and fixing the shaped article according to the fifth aspect to an injection molding mold, and mold-clamping the injection molding mold; pouring a resin into a cavity between the injection molding molds in a state where the injection molding mold is mold-clamped; and after the resin is cured, mold-opening the injection molding mold to take out a molded article in which the shaped article and the cured resin are integrated.

The method for manufacturing a molded article according to an eleventh aspect includes obtaining a molded article obtained by bonding the shaped article according to the fifth aspect to a surface of one member to be selected from a group of a resin member, a metal member, a glass member, a ceramic member, and a wooden member.

Hereinafter, a laminate, a shaped article, a molded article, and methods for manufacturing these according to each embodiment of the present disclosure will be described with reference to the accompanying drawings.

### First Embodiment

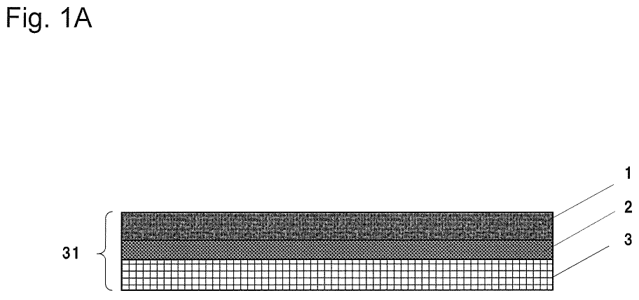

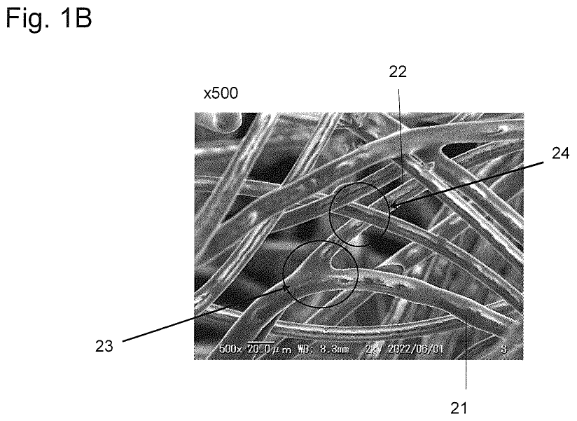

FIG. 1A is a schematic cross-sectional view showing a cross-sectional structure of a laminate 31 according to a first embodiment. FIG. 1B is a SEM photograph (500 times) showing a cross-linked structure of a support layer in the laminate in FIG. 1A. As shown in FIG. 1A, in a laminate 31, a decorative layer 1, a first adhesive layer 2, and a support layer 3 are laminated in this order. As shown in FIG. 1B, the support layer 3 includes two or more kinds of materials different in melting points including a material having a relatively low melting point and a material having a relatively high melting point. According to the laminate according to the first embodiment, the low melting point material included in the support layer is melted by thermocompression bonding, and is fused between the high melting point materials included in the support layer to form a cross-linked structure. Accordingly, the density of the support layer is improved, the hardness of the support layer is improved, and the laminate can stand by itself.

Thus, since alignment can be performed even in the subsequent hot press working and manufacturing step of the molded article, pre-trimming can be performed, and the post-processing step does not need to be performed.

In addition, since the adhesive layer penetrates into the support layer and is bonded and integrated by the anchor effect, the adhesive layer covers the surface of the support layer, and the adhesive layer itself easily follows the shape of the support layer after the subsequent hot press working. Furthermore, the decorative layer similarly follows the shape through the adhesive layer. As a result, the shape followability of the laminate itself is improved, and the shape retention in the shaped article after the hot press working is improved due to the effect of improving the hardness of the support layer itself described above.

In addition, since the laminate is pre-trimmed into a shape in anticipation of a product shape at a stage before being introduced into the method for manufacturing a molded article, and the trimmed laminate is subjected to the above-described hot press processing, a shaped article having a predetermined shape can be obtained, and the shape can be retained even in the shaped article. Furthermore, as will be described below, the shape-retained shaped article is directly fixed to an injection molding mold and molded and integrated with the base material resin, whereby a method for manufacturing a molded article that does not need post-processing processing can be achieved.

Hereinafter, members constituting the laminate will be described.

<Decorative Layer>

The decorative layer 1 is not limited as long as it is a generally used decorative material, such as fabric, natural wood, leather, and a decorative film. The thickness of the decorative layer 1 is not particularly limited according to the characteristics of the decorative material, and is in the range of, for example, 0.1 mm or more and 3.0 mm or less. When the thickness of the decorative layer 1 is in the above range, handleability is good, and defects such as wrinkles and tears during processing are less likely to occur. In addition, when the thickness of the decorative layer 1 is in the above range, the hardness of the entire laminate is suppressed low, the flexibility is maintained, and followability to the product shape is obtained.

<Decorative Film>

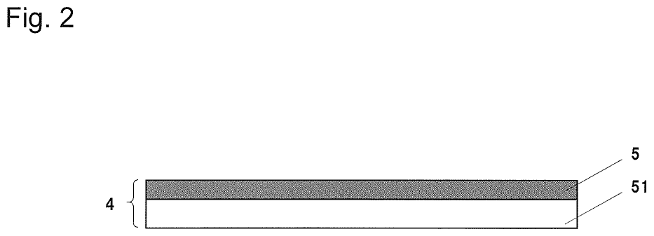

In addition, FIG. 2 is a schematic cross-sectional view showing a cross-sectional structure of a decorative film 4 used as the decorative layer 1 used in the laminate according to the first embodiment. The decorative film 4 is formed by forming a decorative pattern layer 5 on a surface of a base substrate 51. The decorative film 4 is produced using a known printing and coating method such as inkjet printing, gravure printing, screen printing, or a roll coater, and is formed as the decorative pattern layer 5 having an optional color or pattern according to a customer's request. The base substrate 51 of the decorative film 4 may be formed of, for example, a general film material such as a polyethylene terephthalate resin, an acrylic resin, or a polycarbonate resin, and is not particularly limited. The average thickness of the base substrate 51 is, for example, 20 μm or more and 300 μm or less. When the average thickness of the base substrate 51 is in the above range, wrinkles, tears, and warpage are less likely to occur in the base substrate 51 even in thermal drying or the like in the process of forming the decorative pattern layer 5, and the base substrate is easy to handle. In addition, the followability of the decorative film itself to a product shape is good. Furthermore, in the case of being produced as a film roll, since the film thickness of the base substrate 51 is in the above range, the entire weight is not heavy, handling in transportation or the like is also good, and the manufacturing cost can also be suppressed low. In addition, in addition to the pattern layer, a functional layer such as an electronic wiring produced using a known printing and coating method or an image display layer may be formed in the decorative pattern layer 5. As described above, any tint, pattern, and function can be formed in the decorative layer 1 according to a customer's request.

<Protective Layer>

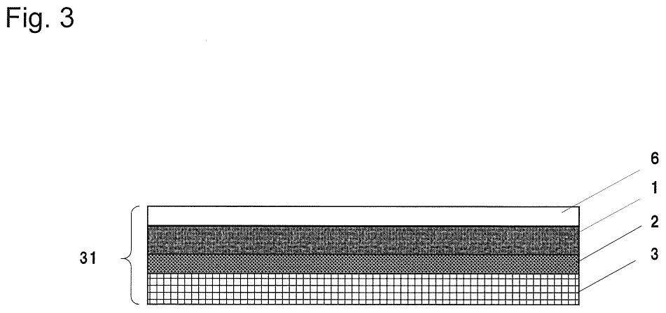

It should be noted that in consideration of durability, a protective layer 6 may be formed on the outermost surface of the decorative layer 1 as shown in FIG. 3. When the protective layer 6 is formed, the film thickness thereof is, for example, in a range of 3 μm or more and 100 μm or less. When the film thickness is in the above range, the protective layer 6 is likely to follow the unevenness shape of the material surface, pinholes are less likely to occur, and the function as the protective layer 6 can be sufficiently exhibited. In addition, the appearance derived from the protective layer 6 does not appear, and the texture of the decorative layer 1 is less likely to be impaired. However, as long as the desired effect can be obtained, there is no problem even with the film thickness outside the above range. Furthermore, a filler, a colorant, or the like can be added to the protective layer 6 itself.

<First Adhesive Layer>

The first adhesive layer 2 has a role of bonding the decorative layer 1 and the support layer 3. The first adhesive layer 2 is made of, for example, a vinyl chloride-vinyl acetate-based copolymer, an olefin-based resin, a polyolefin-based resin, a urethane-based resin, an acryl-based resin, or the like, and is formed in such a form as to completely cover the front surface of the support layer 3. The material is not limited as long as the decorative layer 1 and the support layer 3 can be bonded to each other. In addition, the average film thickness of the first adhesive layer 2 is, for example, 2 μm or more and 200 μm or less. When the average film thickness of the first adhesive layer 2 is in the above range, the film strength of the first adhesive layer 2 itself is sufficiently obtained, and occurrence of peeling failure such as cohesive failure can be suppressed. Furthermore, the adhesive thickness is sufficient, and sufficient adhesive strength to the decorative layer 1 and the support layer 3 can be obtained. In addition, when the average film thickness of the first adhesive layer 2 is in the above range, the manufacturing cost is also suppressed low. A film thickness of 3 μm or more and 100 μm or less is more preferable in consideration of a balance between film strength and adhesive strength and manufacturing cost. In addition, the penetration film thickness of the first adhesive layer 2 (due to the anchor effect) with respect to the support layer 3 is preferably 5 μm or more. When the thickness is less than 5 μm, the adhesive strength to the support layer 3 is insufficient, and there is a possibility that interfacial peeling failure occurs. The process of forming the first adhesive layer 2 is not limited according to the handling form. When the first adhesive layer 2 is handled in a liquid state, the first adhesive layer 2 may be formed in advance on the decorative layer 1 side or may be formed in advance on the support layer 3 side, using a known printing/coating process such as spraying, roll coater, or inkjet coating. Alternatively, when the first adhesive layer 2 is handled in a solid state such as a sheet, the first adhesive layer 2 may be bonded to the decorative layer 1 in advance and then bonded to the support layer 3, or conversely, may be bonded to the support layer 3 in advance and then bonded to the decorative layer 1. Furthermore, the decorative layer 1, the first adhesive layer 2, and the support layer 3 may be bonded simultaneously. Since the first adhesive layer 2 is formed in a form of completely covering the front surface of the support layer 3, followability to the support layer 3 can also be improved, and since the coating portion thereof is less likely to allow air to pass therethrough, the laminate 31 can be directly positioned and fixed to the front surface of the injection molding mold using the vacuum suction mechanism. Furthermore, the coating portion serves as a barrier layer, which reduces the injection molding resin seeping out to the front surface of the laminate 31.

<Support Layer>

The support layer 3 plays a role of improving the strength of the laminate 31 itself by thermocompression bonding and causing the laminate 31 to shape-retain in a predetermined processed shape. In addition, since the first adhesive layer 2 is formed in a form of completely covering the support layer 3, and the decorative layer 1 is formed with interposition of the first adhesive layer 2, the strength improvement of the support layer 3 itself effectively acts on the strength improvement and the shape retention of the laminate 31 itself. That is, the laminate 31 can be made self-standing by itself and can be aligned with the mold at the time of manufacturing the shaped article and at the time of manufacturing the molded article, so that the post-processing step can be made unnecessary.

The material, structure, thickness, and the like of the support layer 3 can be selected according to the application. The support layer 3 includes two or more kinds of materials different in melting points including a material having a relatively low melting point and a material having a relatively high melting point. Examples thereof include the configuration in which when the material is a polyethylene terephthalate-based material, the weight ratio of polyethylene terephthalate short fibers having an average fineness of 0.6 to 3.3 dtex (decitex) to the heat-sealable polyester short fibers having a core-sheath structure containing a low melting point component is in the range of 10/90 to 90/10. (Example 1).

As a step of manufacturing the support layer, fibers spun from a card spinning machine may be obliquely folded over a cloth to form a web, and after fiber entanglement by a needle punch machine, the heat-sealable polyester short fibers may be further melted by a heat treatment apparatus to form a nonwoven fabric sheet as a support layer. The heat-sealable polyester short fiber having a core-sheath structure is a composite fiber having a core-sheath structure in which the core portion is made of polyethylene terephthalate being a material of a high melting point and the sheath portion is made of copolymerized polyester being a material of a low melting point. In addition, the melting point of the low-melting material of the sheath portion in the heat-sealable polyester short fiber is preferably in the range of 100° C. to 160° C. so that molding can be performed even when the temperature of the mold is relatively low.

In addition, when a nonwoven fabric is used for the support layer 3, a multilayer structure in which each interlayer is deformable in the shearing direction is formed. Accordingly, the respective interlayers of the support layer 3 are deformed to each other in the shear direction against tensile deformation and compressive deformation generated at the time of hot press working, and play a role of a cushioning material, whereby wrinkles and tears of the laminate 31 can be suppressed. The number of layers of the multilayer structure is preferably 5 to 30. If the number of layers is less than 5, the range in which deformation can be made in the shearing direction is narrowed, and the effect on wrinkles and tears of the laminate 31 is reduced. On the other hand, if the number of layers is larger than 30, the laminate 31 itself becomes too thick, so that the circumferential length difference at the time of bending becomes large, and it is difficult to sufficiently follow the product shape. In consideration of the effect on wrinkles and tears and the bending workability, the number of layers of the multilayer structure is more preferably 10 to 20. However, the number of layers of the multilayer structure is not limited as long as the above-described effect can be obtained.

As shown in FIG. 1B, the copolymerized polyester being a material having a low melting point of the sheath portion of the heat-sealable polyester short fiber 21 having a core-sheath structure is thermally melted by thermocompression bonding, and is fused with another heat-sealable polyester short fiber 21 or polyethylene terephthalate short fiber 22 to form a cross-linked structure. It should be noted that as shown in FIG. 1B, in the entire support layer, the entire copolymerized polyester being a material having a low melting point does not have to be thermally melted, and the fused portion 23 and the non-fused portion 24 may be present.

Furthermore, in the weight ratio of the used fibers in the support layer 3 described in Example 1, for example, polyethylene terephthalate short fibers/heat-sealable polyester short fibers having a core-sheath structure=10/90 to 90/10, and more preferably 30/70 to 70/30. When the weight ratio of the heat-sealable polyester short fibers having a core-sheath structure is within the above range, the texture is maintained at an appropriate hardness, the mold followability is good, and sufficient molding accuracy is obtained. Furthermore, since the processing temperature by the heat treatment apparatus also affects the texture of the nonwoven fabric, processing at 100° C. to 160° C. is preferable, but when the mold followability is good and sufficient molding accuracy is obtained, the processing temperature is not necessarily limited to this processing temperature range.

It should be noted that in Example 1, as the polyethylene terephthalate-based material, a hybrid combination of a polyethylene terephthalate short fiber being a material having a high melting point and a heat-sealable polyester short fiber having a core-sheath structure including a core portion made of a material having a high melting point and a sheath portion made of a material having a low melting point has been described, but the present disclosure is not limited thereto. The heat-sealable polyester short fiber having the above core-sheath structure is what is called a composite fiber containing a high melting point material and a low melting point material in one fiber. The fiber contained in the support layer may be a combination of a basic low-melting material and a high-melting material without using a composite fiber having a core-sheath structure or the like. In addition, as described above, the material, the structure, and the like can be selected according to the application. For example, fibers such as nylon-based fibers, polypropylene-based fibers, and polyethylene-based fibers may be used for raw materials, or different raw materials may be used in combination. Furthermore, the fiber structure of the composite fiber may be formed not by a core-sheath structure but by a sea-island structure, a side-by-side structure, or the like. Furthermore, a plurality of types of composite fibers may be used in combination. In addition, as long as the role of the support layer 3 of improving the strength of the laminate 31 itself and retaining the shape of the laminate 31 in a predetermined processed shape can be satisfied by thermocompression bonding, the method of thermocompression bonding is not limited.

<Method for Manufacturing Laminate>

Next, a molding processing process (manufacturing method) of the laminate 31 will be described.

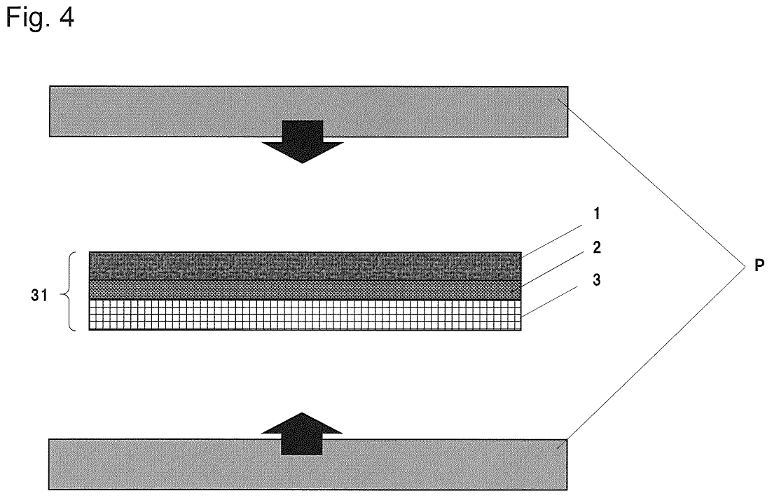

FIG. 4 is a schematic cross-sectional view showing one step of the method for manufacturing the laminate 31 according to the first embodiment.

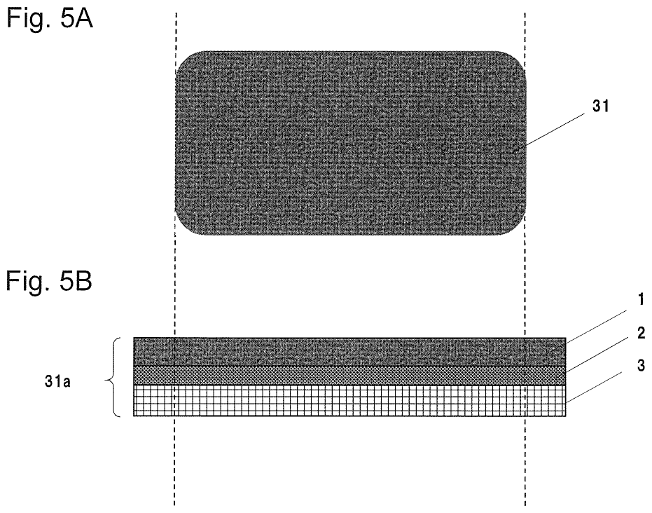

FIG. 5A is a plan view showing a configuration in which the laminate 31 according to the first embodiment is pre-trimmed to a predetermined shape, and FIG. 5B is a cross-sectional view of the laminate before trimming.

FIG. 4 shows a laminate state in which the decorative layer 1 and the support layer 3 are integrated by thermocompression bonding with interposition of the first adhesive layer 2. The laminate 31 is formed using a thermocompression bonding device P capable of applying heat and pressure. Examples of the thermocompression bonding device P include known devices such as a general-purpose press device that pressurizes with upper and lower heated plates, a multi-stage press device, a vacuum laminator device, and a roll-to-roll press device. With these devices, the manufactured laminate 31 can self-stand in a firm sheet state, that is, the laminate 31 on its own, so that handleability at the time of processing can be improved as compared with the case of the decorative layer 1 alone.

FIGS. 5A and 5B show a laminate 31 pre-trimmed to a shape in consideration of unevenness and bending of a product shape. Examples of the trimming method include shape punching using a Thomson type, laser cutting, and hand cutting, but are not limited as long as trimming to a predetermined product shape can be performed. As described above, since trimming is performed to a predetermined product shape at the initial stage of the molding processing process, there is no need to provide a positioning portion in a margin other than the product shape, and post-processing after hot press working is not necessary.

<Method for Manufacturing Shaped Article>

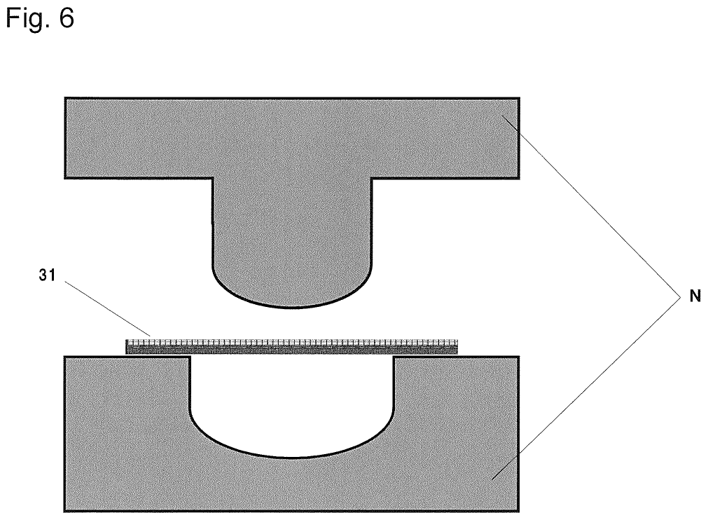

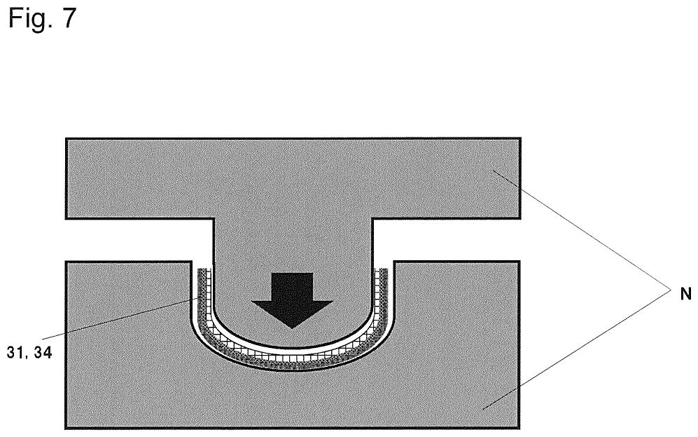

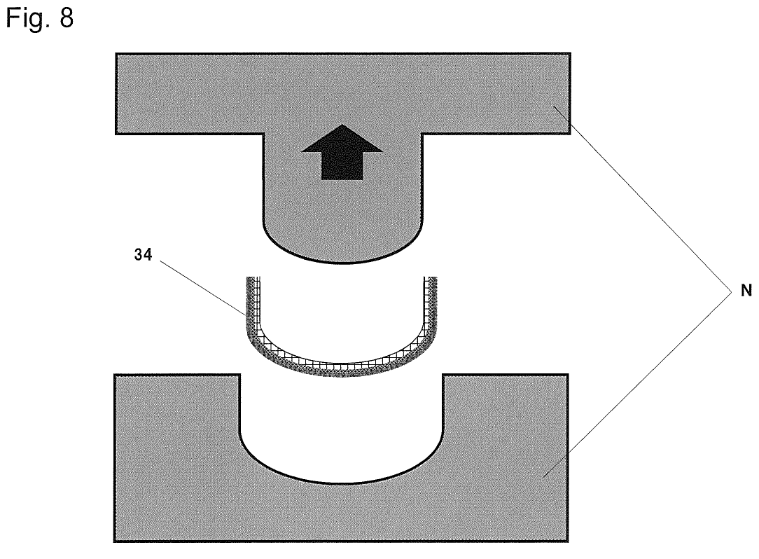

FIG. 6 is a schematic cross-sectional view showing a state before hot press working in the method for manufacturing a shaped article according to the first embodiment. FIG. 7 is a schematic cross-sectional view showing a state at the time of hot press working in the method for manufacturing a shaped article according to the first embodiment. FIG. 8 is a schematic cross-sectional view showing a state after hot press working in the method for manufacturing a shaped article according to the first embodiment.

FIG. 6 shows a state in which the pre-trimmed laminate 31 is installed on the working surface of the hot press working machine N before the hot press working. Since the laminate 31 can stand by itself, the laminate 31 can be installed on the working surface of the hot press working machine N using, for example, a positioning mechanism such as an L-shaped fitting along the shape of the laminate 31 after trimming.

FIG. 7 shows a shaped article 34 in which the laminate 31 is hot-pressed by the hot press working machine N and shaped into a predetermined product shape. At this time, the laminate 31 is heated by heat conduction from the working surface of the hot press working machine N. The first adhesive layer 2 has flexibility improved due to its heat, and thus is likely to be deformed. Accordingly, the decorative layer 1 and the support layer 3 adhering to the first adhesive layer 2 at the interface are also likely to be deformed. In addition, among the materials constituting the support layer 3, since a material having a low melting point is thermally melted by heating, the material penetrates between materials having a high melting point and is fused to form a cross-linked structure. Since the cross-linked structure is formed, the hardness of the support layer 3 is improved. Since the process of forming the cross-linked structure and the process of hot pressing into a product shape proceed simultaneously in parallel, the followability of the support layer 3 to the product shape and the hardness are improved, so that the shape retention is improved. As a result, the laminate 31 changes to the shaped article 34 having a predetermined product shape, and the shape followability to the product shape and the shape retention are improved. The processing temperature during the hot press working is not limited as long as the working temperature is in a temperature range of promoting the flexibility of the first adhesive layer 2 and the support layer 3 and the formation of the cross-linked structure, but is preferably in a temperature range of 80° C. or higher.

After the hot press working in FIG. 8, the cross-linked structure formed in the support layer 3 in FIG. 7 is maintained, and the shaped article 34 which is shape-retained in the product shape is obtained even after being taken out from the working surface of the hot press working machine N.

<Method for Manufacturing Molded Article>

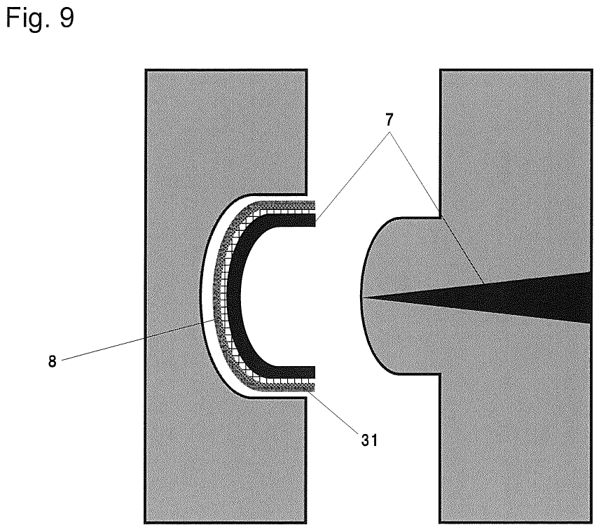

FIG. 9 is a schematic cross-sectional view showing a molded article 8 obtained by injection molding in the method for manufacturing a molded article according to the first embodiment. Next, at the time of injection molding in FIG. 9, the molded article 8 having the shaped article 34 on the product appearance surface can be obtained by installing the shaped article 34 so as to be fitted into the product shape portion of the injection molding mold and molding and integrating the shaped article 34 with the base material resin 7. Examples of the base material resin 7 include general-purpose molding resins such as a PMMA resin, an ABS resin, a PS resin, and a PC resin. In addition, it is also possible to cope with resins that require molding at a high temperature, such as resins for optical applications and super engineering resins. It should be noted that since the shaped article 34 is self-standing, has high shape retention, can be aligned in a mold, and as shown in FIG. 5, is pre-trimmed corresponding to the molded article at the stage of the laminate 31 before the hot press working in FIG. 6, the obtained molded article 8 does not need post-processing.

It should be noted that although the molded article 8 in FIG. 9 shows a state in which only the appearance surface is covered with the decorative layer 1, it is also possible to obtain a molded article involving the shaped article 34 not only on the appearance surface but also on the appearance back surface side by forming a fold on the end surface of the shaped article 34 at the time of hot press working shown in FIG. 8 and then integrally molding the shaped article 34 and the base material resin 7 with the fold as a starting point at the time of injection molding. The length, angle, and the like of the fold can be changed according to the target product shape. As described above, by designing the mold structure according to the product shape and using the process of the present disclosure, the method for finishing the product shape can also be optionally supported. In particular, in the process of involving the shaped article 34 up to the appearance back surface side described above, it is difficult for the conventional process in which the positioning mechanism is provided in the margin other than the product shape to achieve eliminating post-processing, and the edge of the method for manufacturing a molded article according to the first embodiment of the present disclosure can be maximized. With these configurations, it is possible to achieve a method for manufacturing a molded article that does not require post-processing.

### Second Embodiment

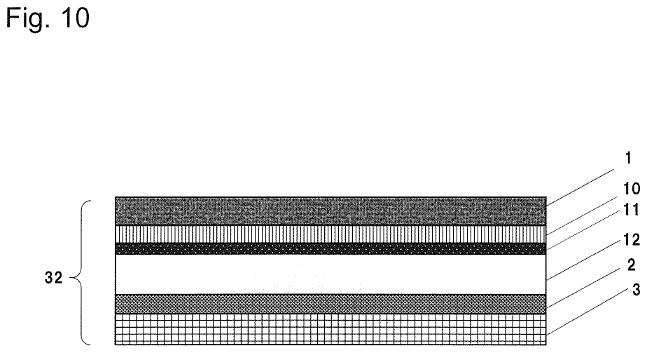

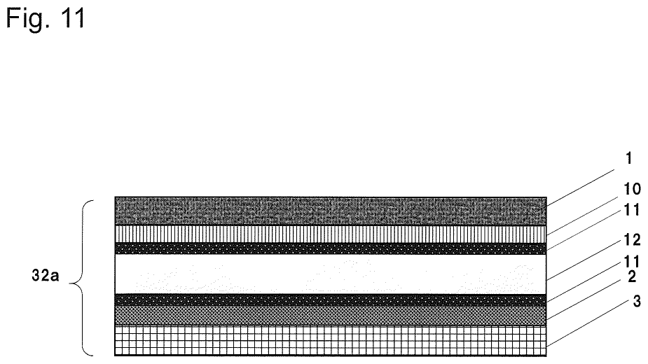

FIGS. 10 and 11 are schematic cross-sectional views showing a cross-sectional structure of a laminate 32 according to a second embodiment. It should be noted that components having the same functions as those of the first embodiment will be denoted by the same reference numerals and described. A laminate 32 shown in FIG. 10 is configured as a laminate 32 in which a decorative layer 1, a second adhesive layer 10, a primer layer 11, a base material layer 12, a first adhesive layer 2, and a support layer 3 are formed in this order. In addition, in a laminate 32a of another example shown in FIG. 11, the decorative layer 1, the second adhesive layer 10, the primer layer 11, the base material layer 12, the primer layer 11, the first adhesive layer 2, and the support layer 3 are formed in this order.

<Second Adhesive Layer>

The second adhesive layer 10 is formed for the purpose of bonding the decorative layer 1 and the base material layer 11. The component of the second adhesive layer 10 is made of, for example, a vinyl chloride-vinyl acetate-based copolymer, an olefin-based copolymer, a polyolefin-based copolymer, a urethane-based copolymer, an acryl-based copolymer, or the like, but is not limited to the above-described material as long as the purpose of adhesion can be achieved. For the purpose of improving the adhesive strength, the component may be made of a component that forms a cross-linked structure such as a urethane bond. The average film thickness is 3 μm or more and 200 μm or less. When the average film thickness is in the above range, the adhesive thickness is sufficient, and sufficient adhesive strength is obtained. In addition, when the average film thickness is in the above range, the manufacturing cost is suppressed low. The average film thickness is more preferably 5 μm or more and 100 μm or less.

<Primer Layer>

The primer layer 11 has a role of firmly bonding the base material layer 12 to the first adhesive layer 2 or the second adhesive layer 10, and is provided on one surface or both surfaces of the base material layer 12. For example, when the components of the first adhesive layer 2 and the second adhesive layer 10 are acrylic adhesives, the components can be selected in consideration of compatibility such as providing the primer layer 11 of the same acrylic component. In addition, by forming a cross-linked structure such as a urethane bond in the primer layer 11, the film strength of the primer layer 11 itself can be improved, or if the first adhesive layer 2 and the second adhesive layer 10 have similar components, a cross-linked structure can be formed with each of them, and the interlayer adhesive force itself can be greatly improved. It should be noted that when the first adhesive layer 2 and the second adhesive layer 10 can be directly and firmly bonded to the base material layer 12, it is not always necessary to provide the primer layer 11.

<Base Material Layer>

The base material layer 12 plays a role of improving shape followability of the laminates 32 and 32a and improving durability against appearance defects due to resin heat and pressure during injection molding. The material is made of a general-purpose high polymer film generally used as an industrial product such as polyethylene terephthalate, polycarbonate, acrylic, or polyolefin. The base material layer 12 does not need to be made of only one type of component, and may be subjected to a treatment in combination with another substance such as easy adhesion coating on one side or both sides thereof. In addition, surface modification treatment such as corona treatment or plasma treatment may be applied. Furthermore, the base material layer 12 may be subjected to treatment for enhancing designability and functionality. For example, in the case of designability, printing of a pattern, material coloring of the base material layer 12 itself, and the like are exemplified. In addition, in the case of functionality, possessing an IR/UV cut function, forming an electronic circuit using a conductive material on the base material layer 12, and the like are exemplified. As described above, as long as the original purpose of the base material layer 12 is achieved, that is, the improvement in the shape followability of the laminate 32 and the improvement in durability at the time of injection molding, other designability and functionality can be assigned without limitation. It should be noted that the laminate 32 can be manufactured by a manufacturing method by thermocompression bonding as in FIG. 4 of the first embodiment, the shaped article can be further manufactured by hot press working as in FIGS. 5 to 8 of the first embodiment, and the molded article can be processed by the manufacturing method of the molded article described above with reference to FIG. 9.

With the configuration of the second embodiment, a base material layer 12 is provided between the decorative layer 1 and the support layer 3, whereby the strength of the laminate 32 itself can be improved and the laminates 32 and 32a in which the shape followability during the subsequent hot press working and the durability against the heat and pressure of resin during injection molding are improved can be implemented.

### Third Embodiment

<Molded Article>

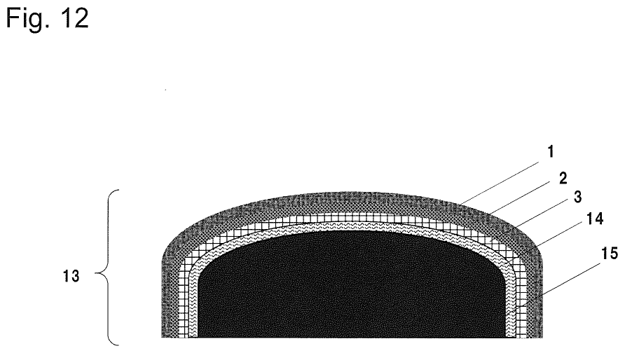

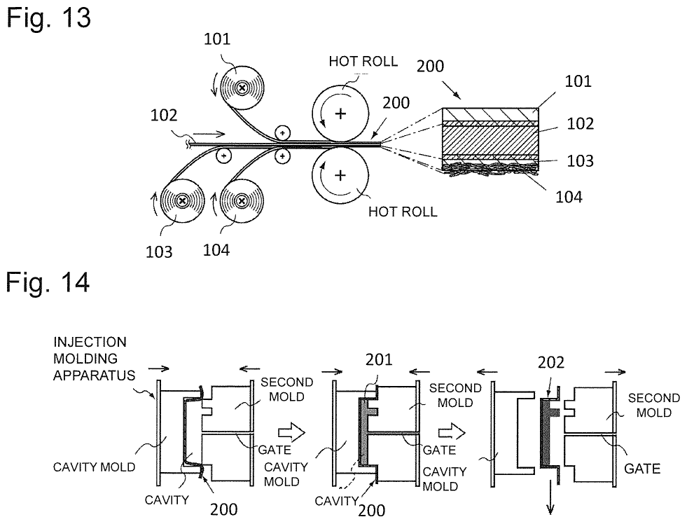

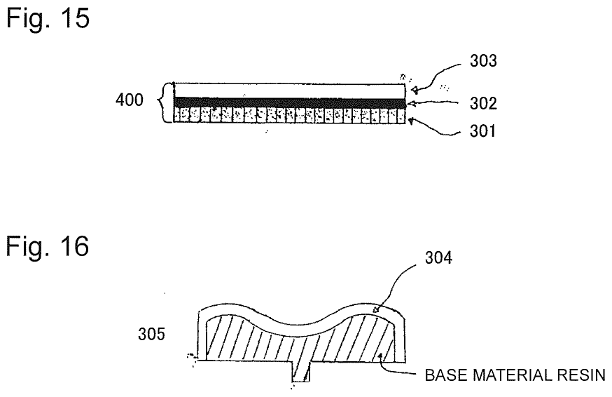

FIG. 12 is a schematic cross-sectional view showing a cross-sectional structure of a molded article 13 according to a third embodiment. It should be noted that components having the same functions as those of the first embodiment and the second embodiment will be denoted by the same reference numerals and described. The molded article 13 according to the third embodiment has a configuration in which a laminate 31, a third adhesive layer 14, and a reinforcing layer 15 formed in a separate step are sequentially laminated and integrated.

<Third Adhesive Layer>

The third adhesive layer 14 has an average film thickness of 1 μm or more and 100 μm or less, and may be in the form of a liquid, a sheet shape, a thermoplastic adhesive, a thermosetting adhesive, or the like. In addition, the component may be made of, for example, a vinyl chloride-vinyl acetate-based copolymer, an olefin-based copolymer, a polyolefin-based copolymer, a urethane-based copolymer, an acryl-based copolymer, or the like, and is not limited thereto as long as the purpose of bonding the support layer 3 and the reinforcing layer 15 can be achieved. It should be noted that the third adhesive layer 14 may be formed in advance on the back surface of the support layer 3 of the laminate 31, or may be formed in advance on the front surface of the reinforcing layer 15.

<Reinforcing Layer>

The material of the reinforcing layer 15 can be selected according to the application. For example, a general-purpose molded resin such as a PMMA resin, an ABS resin, a PS resin, or a PC resin, a resin for optical use, a super engineering resin, a metal member, a glass member, a ceramic member, a wooden material, or the like can be selected according to a required application, and a process for manufacturing them is also not limited. The component of the third adhesive layer 14 may be selected according to the material of the reinforcing layer 15. Examples of the process of integrating the laminate 31 and the reinforcing layer 15 include hand bonding and vacuum pressure molding, and are not limited as long as the laminate 31 and the reinforcing layer 15 can be bonded with interposition of the third adhesive layer 14. It should be noted that as in the first embodiment, it is also possible to obtain a molded article in which the laminate 31 is involved to the appearance back surface side by forming a fold in the laminate 31 at the time of hot press working and integrating the laminate with the reinforcing layer 15.

Incidentally, in the third embodiment, the case of a molded article using the laminate 31 according to the first embodiment is taken as an example, but the laminates 32 and 32a described above in the second embodiment can also be integrated with the reinforcing layer 15 to form a molded article by a similar process.

The laminate, the shaped article, and the molded article according to the present disclosure contribute to high functionality and high designability in a field requiring decoration such as exterior of various household electrical appliances and in-vehicle interior.

What is claimed is:

1. A laminate comprising a decorative layer, a first adhesive layer, and a support layer laminated in this order,
wherein the support layer includes two or more kinds of materials having different melting points including a material having a relatively low melting point and a material having a relatively high melting point.

2. The laminate according to claim 1, wherein the material having a low melting point included in the support layer is fused between the materials having a high melting point included in the support layer to form a cross-linked structure.

3. The laminate according to claim 1, wherein the first adhesive layer penetrates into the support layer and is bonded and integrated with the support layer, and the first adhesive layer covers a front surface of the support layer.

4. The laminate according to claim 1, wherein a base material layer is formed between the decorative layer and the first adhesive layer.

5. A shaped article comprising a decorative layer, a first adhesive layer, and a support layer laminated in this order,
wherein the support layer includes two or more kinds of materials having different melting points including a material having a relatively low melting point and a material having a relatively high melting point, and
the material having a low melting point included in the support layer is fused between the materials having a high melting point included in the support layer to form a cross-linked structure, and a shape is retained.

6. A molded article comprising:
the shaped article according to claim 5; and
an injection molding resin integrated with the shaped article.

7. A molded article comprising:
one member to be selected from a group of a resin member, a metal member, a glass member, a ceramic member, and a wooden member; and
the shaped article according to claim 5 bonded to a surface of the member.

8. A method for manufacturing a laminate, the method comprising:
laminating a decorative layer, a first adhesive layer, and a support layer in this order; and
thermocompression-bonding the decorative layer, the first adhesive layer, and the support layer which are laminated.

9. A method for manufacturing a shaped article, the method comprising:
trimming the laminate according to claim 1 into a predetermined shape; and
aligning and fixing the trimmed laminate, and performing hot press working.

10. A method for manufacturing a molded article, the method comprising:
aligning and fixing the shaped article according to claim 5 to an injection molding mold, and mold-clamping the injection molding mold;
pouring a resin into a cavity between the injection molding molds in a state where the injection molding mold is mold-clamped; and
after the resin is cured, mold-opening the injection molding mold to take out a molded article in which the shaped article and the cured resin are integrated.

11. A method for manufacturing a molded article, the method comprising obtaining a molded article obtained by bonding the shaped article according to claim 5 to a surface of one member to be selected from a group of a resin member, a metal member, a glass member, a ceramic member, and a wooden member.
